(19) United States
(12) Patent Application Publication
(10) Pub. No.: US 2019/0313108 A1
(43) Pub. Date: Oct. 10, 2019

(54) NON-SQUARE BLOCKS IN VIDEO CODING

(71) Applicant: QUALCOMM Incorporated, San Diego, CA (US)

(72) Inventors: Li Zhang, San Diego, CA (US); Kai Zhang, San Diego, CA (US); Wei-Jung Chien, San Diego, CA (US); Marta Karczewicz, San Diego, CA (US)

(21) Appl. No.: 16/375,665

(22) Filed: Apr. 4, 2019

Related U.S. Application Data
(60) Provisional application No. 62/653,514, filed on Apr. 5, 2018.

(51) Int. Cl. H04N 19/18; H04N 19/96; H04N 19/176; H04N 19/122; H04N 19/129; H04N 19/159

(52) U.S. Cl. CPC H04N 19/18; H04N 19/96; H04N 19/159; H04N 19/122; H04N 19/129; H04N 19/176

(57) ABSTRACT

Techniques are described for decoding and encoding video data utilizing non-square coefficient groups (CGs). A coefficient group includes a plurality of coefficient values for a block of coefficient values. In one or more examples, the CGs that form at least part of the block of coefficient values are non-square shaped.

This application claims the benefit of U.S. Provisional Application No. 62/653,514, filed Apr. 5, 2018, the entire contents of which are incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to mode dependent coefficient scanning (MDCS) and coding group (CG) design for non-square blocks in video coding. The techniques may be applicable to the entropy coding module in block-based hybrid video coding. The example techniques may be applied to existing video codecs, such as HEVC (High Efficiency Video Coding), VVC (Versatile Video Coding) or be an efficient coding tool in further video coding standards.

In one example, the disclosure describes a method of decoding video data, the method comprising determining, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values, transforming the coefficient values of the block of coefficient values into residual samples of a residual block, and reconstructing the current block based on a prediction block and the residual block.

In one example, the disclosure describes a method of encoding video data, the method comprising determining residual samples of a residual block based on a difference between a current block that is non-square and a prediction block, transforming the residual samples of the residual block into a block of coefficient values, partitioning the block of coefficient values into one or more non-square coefficient groups, wherein the one or more non-square coefficient groups together form at least part of the block of coefficient values, and coefficient values for the one or more non-square coefficient groups form at least a part of the coefficient values for the block of coefficient values, and signaling information indicative of the coefficient values for the one or more square coefficient groups.

In one example, the disclosure describes a device for decoding video data, the device comprising a memory configured to store a prediction block and a video decoder comprising at least one of fixed-function or programmable circuitry. The video decoder is configured to determine, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values, transform the coefficient values of the block of coefficient values into residual samples of a residual block, and reconstruct the current block based on the prediction block stored in memory and the residual block.

In one example, the disclosure describes a computer-readable storage medium storing instructions that when executed cause one or more processors to determine, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values, transform the coefficient values of the block of coefficient values into residual samples of a residual block, and reconstruct the current block based on a prediction block and the residual block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example transform scheme based on residual quadtree in the High Efficiency Video Coding (HEVC) standard.

FIGS. 3A-3C are conceptual diagrams illustrating coefficient scans based on coding groups (CGs) in HEVC.

FIGS. 4A and 4B are conceptual diagrams illustrating an example quadtree binary tree (QTBT) structure, and a corresponding coding tree unit (CTU).

FIGS. 5A-5E are conceptual diagrams illustrating a QTBT structure.

FIG. 6 is conceptual diagram illustrating a QTBT structure.

FIGS. 7A-7D are conceptual diagrams illustrating an example of multiple CG sizes within one block.

FIG. 8 is a block diagram illustrating an example video encoder that may perform the techniques of this disclosure.

FIG. 9 is a block diagram illustrating an example video decoder that may perform the techniques of this disclosure.

FIG. 10 is a flowchart illustrating an example method of encoding video data.

FIG. 11 is a flowchart illustrating an example method of decoding video data.

### DETAILED DESCRIPTION

In general, this disclosure describes techniques related to mode dependent coefficient scanning (MDCS) and coefficient group (CG) design for non-square blocks in video coding such as in the versatile video coding (VVC) standard under development. The techniques may be applicable to the entropy coding module in block-based hybrid video coding. The example techniques may be applied to existing video codecs, such as HEVC (High Efficiency Video Coding), or be an efficient coding tool in further video coding standards.

As described in more detail, a video encoder generates a residual block based on a difference between a current block and a prediction block. The residual block may include residual values indicating differences between samples in the current block and corresponding samples in the prediction block. The video encoder transforms the residual block into a block of coefficient values (e.g., transform coefficient block). The video encoder may partition the block of coefficient values into a one or more coefficient groups (CGs) and generate information indicative of the coefficient values in each of the one or more CGs. The video encoder signals the information indicative of the coefficient values in each of the one or more CGs.

A video decoder receives the information indicative of the coefficient values in each of the one or more CGs. Based on the received coefficient values in each of the one or more CGs, the video decoder determines a block of coefficient values and performs an inverse transform to generate a residual block.

In some cases, the size of the CGs is limited to being square sized (e.g., N×N). However, such a limitation on the size of the CGs may not be able to capture local residual characteristics and different block types. For example, the block being encoded or decoded (e.g., current block) may be a non-square shaped block. In such examples, limiting the size of the CGs to be square blocks may result in inefficient ways of scanning coefficient values within the CGs or result in the CGs not properly demarcating between varying coefficient values. For example, it may have been better for coding if a coefficient value was in a second CG instead of a first CG, but due to the requirement that the CGs be square, the coefficient value is in the first CG. Such issues may be present where the current block is a non-square shape, but the such issues need not necessarily only be present in cases where the current block is a non-square shape. The current block may have a non-square shape in VVC due to the quad-tree-binary-tree (QTBT) partitioning or the triple tree portioning.

In one or more examples, the CGs, within a block of coefficients, may be non-square shaped. Moreover, in some examples, there may be multiple CG sizes within a block of coefficients. In this manner, the example techniques may provide a technical solution with a practical application to address deficiencies such as those explained above for when CGs are limited to be square and/or for when CG sizes are limited to be the same within the block of coefficients.

In some examples, all the CGs within a block of coefficient values all have the same size and are non-square. In some examples, one or more of the CGs within a block of coefficient values are non-square and one or more of the CGs within the block of coefficient values are square. Square refers to equal number of samples or coefficients horizontally and vertically, and non-square refers to the number of samples or coefficients horizontally being different than the number of samples or coefficients vertically. Also, in some examples, one or more of the CGs within a block of coefficient values are of the same size and other CGs are of a different size.

To generate information indicative of the coefficient values, the video encoder may scan the coefficient values in CGs (e.g., diagonal, horizontal, vertical). In some examples, an 8×8 block of coefficient values may be divided into 4×4 sized CGs (in this example, the CGs are square), and the video encoder may scan the coefficient values, within each CG, in a diagonal scan and scan the CGs diagonally. In MDCS, the video encoder may scan CGs based on a coding mode used to encode the current block.

The video decoder may similarly utilize the scan order to reconstruct the CGs, and the result of the reconstructing the CGs is the block of coefficient values. For instance, each CG is a part of the block of coefficient values, and therefore, by reconstructing the CGs, the video decoder may reconstruct the block of coefficient values. As an example, assume that the video decoder determines that a diagonal scan was used by the video encoder to scan the coefficient values in the CGs. In this example, the video decoder receives the information indicative of the coefficient values and may utilize the diagonal scan as a way to determine the location of the coefficient values in the CGs. Similar to the video encoder, for MDCS, the video decoder may determine the scan order based on the coding mode that is to be used to decode the current block (e.g., based on the coding mode that was used to encode the current block).

In some techniques, MDCS was limited to cases where the current block being encoded or decoded was a square block. This disclosure describes example techniques of using MDCS even in cases where the block being encoded or decoded is not a square block. For instance, in some other techniques, for a non-square block that was being encoded or decoded, the scan order for the CGs of this non-square block was limited to being diagonal. In one or more examples described in this disclosure, the scan order for the CGs of the non-square block, regardless of whether the CGs are square or non-square CGs, may be based on the coding mode (e.g., based on MDCS).

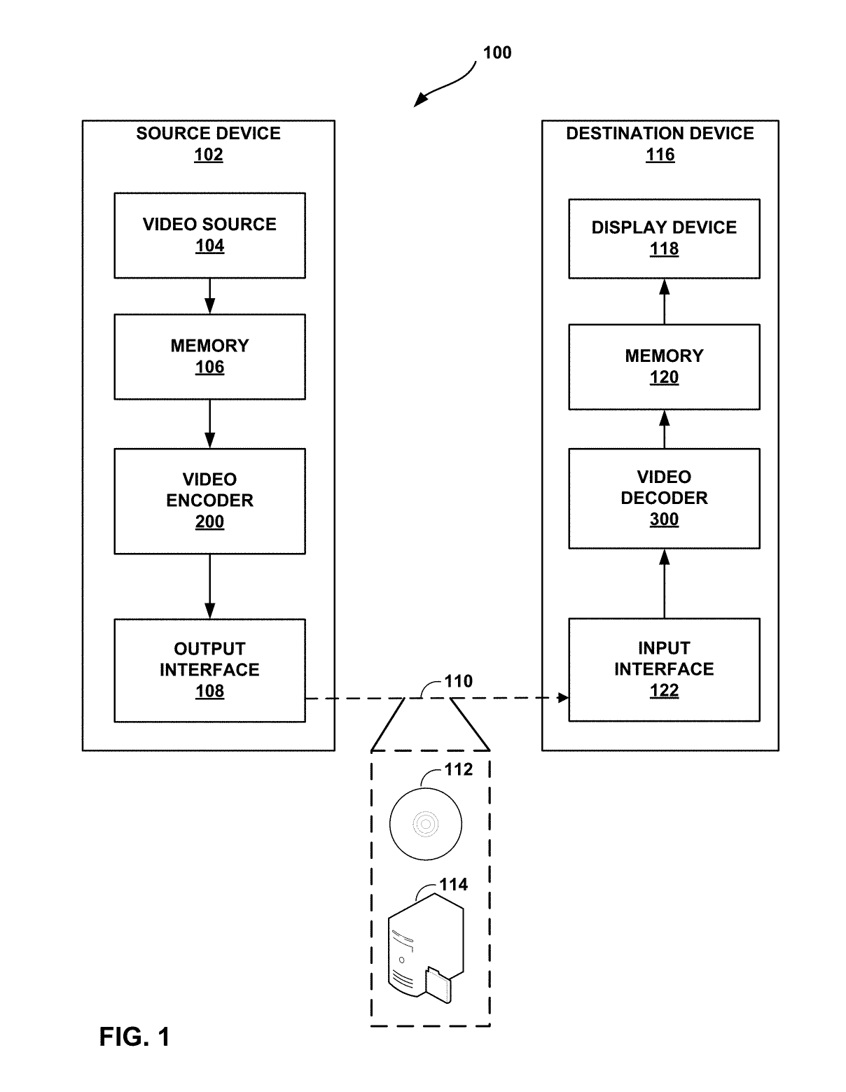

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques described in this disclosure. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques described in disclosure. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM) or ITU-T H.266, also referred to as Versatile Video Coding (VVC). A recent draft of the VVC standard is described in Bross, et al. “Versatile Video Coding (Draft 4),” Joint Video Experts Team (WET) of ITU-T SG 16 WP 3 and ISO/IEC JTC 1/SC 29/WG 11, 13^{th} Meeting: Marrakech, Mass., 9-18 Jan. 2019, JVET-M1001-v5 (hereinafter “VVC Draft 4”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM or VVC. According to JEM or VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. JEM provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom). This disclosure may use terms such as current CU, current block, current picture, current slice, etc. In the context of this disclosure, the term current is intended to identify a CU, block, picture, slice, etc. that is currently being coded, as opposed to, for example, previously or already coded CUs, blocks, pictures, and slices or yet to be coded CUs, blocks, pictures, and slices.

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

A PPS is, for example, a syntax structure that contains syntax elements that apply to zero or more entire coded pictures as determined by a syntax element found in each slice segment header. An SPS is, for example, a syntax structure that contains syntax elements that apply to zero or more entire coded video sequences (CVSs) as determined by the content of a syntax element found in the PPS referred to by a syntax element found in each slice segment header. A VPS is, for example, a syntax structure that contains syntax elements that apply to zero or more entire CVSs as determined by the content of a syntax element found in the SPS referred to by a syntax element found in the PPS referred to by a syntax element found in each slice segment header.

In this manner, video encoder 200 may generate a bitstream including encoded video data, e.g., syntax elements describing partitioning of a picture into blocks (e.g., CUs) and prediction and/or residual information for the blocks, including syntax structures. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

The following describes example video coding standards, such as H.264.AVC and HEVC techniques. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

The latest HEVC draft specification, and referred to as HEVC WD hereinafter, is available from http://phenix.int-evey.fr/jct/doc_end user/documents/14_Vienna/wg11/JCTVC-N1003-v1.zip. The latest draft of the H.265 specification is: ITU-T H.265, Series H: Audiovisual and Multimedia Systems, Infrastructure of audiovisual services—Coding of moving video, Advanced video coding for generic audiovisual services, The International Telecommunication Union. December 2016, and herein referred to as H.265 or HEVC.

ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. And the latest version of reference software, i.e., Joint Exploration Model 7 (JEM 7) could be downloaded from: https://jvet.hhi.fraunhofer.de/svn/svn_HMJEMSoftware/tags/HM-16.6-JEM-7.0/Algorithm description of Joint Exploration Test Model 7 (JEM7) could be referred to JVET-G1001. As also noted above, a recent draft of the VVC standard is described in Bross, et al. “Versatile Video Coding (Draft 4),” Joint Video Experts Team (JVET) of ITU-T SG 16 WP 3 and ISO/IEC JTC 1/SC 29/WG 11, 13^{th} Meeting: Marrakech, MA, 9-18 Jan. 2019, JVET-M1001-v5 (hereinafter “VVC Draft 4”).

As examples, design aspects of HEVC are introduced below, such as the transform coefficient coding, as well as Context-Adaptive Binary Arithmetic Coding (CABAC).

The CU structure in HEVC is described. In HEVC, the largest coding unit in a slice is called a coding tree unit (CTU). A CTU contains a quad-tree the nodes of which are coding units. The size of a CTU can be ranges from 16×16 to 64×64 in the HEVC main profile (although technically 8×8 CTU sizes can be supported). A coding unit (CU) could be the same size of a CTU although and as small as 8×8. Each coding unit is coded with one mode. When a CU is inter coded, it may be further partitioned into 2 or 4 prediction units (PUs) or become just one PU when further partition doesn't apply. When two PUs are present in one CU, they can be half size rectangles or two rectangle size with 1/4 or 3/4 size of the CU.

When a CU is inter-coded, one set of motion information is present for each PU. In addition, each PU is coded with a unique inter-prediction mode to derive the set of motion information.

Context-adaptive binary arithmetic coding in HEVC is described. CABAC is a method of entropy coding first introduced in H.264/AVC, described in D. Marpe, H. Schwarz, and T. Wiegand, “Context-based adaptive binary arithmetic coding in the H.264/AVC video compression standard,” IEEE Trans. Circuits Syst. Video Technol., vol. 13, no. 7, pp. 620-636, July 2003, and now used in the newest standard High Efficiency Video Coding (HEVC). It involves three main functions: binarization, context modeling, and arithmetic coding. Binarization maps syntax elements to binary symbols (bins) which are called bin strings. Context modeling estimates the probability of the bins. Finally, binary arithmetic coder compresses the bins to bits based on the estimated probability.

Transform scheme based on residual quadtree in HEVC is described. To adapt the various characteristics of the residual blocks, a transform coding structure using the residual quadtree (RQT) is applied in HEVC, which is briefly described in the following: http://www.hhi.fraunhofer.de/fields-of-competence/image-processing/researchgroups/image-video-coding/hevc-high-efficiency-video-coding/transform-coding-using-the-residual-quadtree-rqt.html.

Each picture is divided into coding tree units (CTU), which are coded in raster scan order for a specific tile or slice. A CTU is a square block and represents the root of a quadtree, i.e., the coding tree. The CTU size may range from 8×8 to 64×64 luma samples, but typically 64×64 is used. Each CTU can be further split into smaller square blocks called coding units (CUs). After the CTU is split recursively into CUs, each CU is further divided into prediction units (PU) and transform units (TU). The partitioning of a CU into TUs is carried out recursively based on a quadtree approach, therefore the residual signal of each CU is coded by a tree structure namely, the residual quadtree (RQT). The RQT allows TU sizes from 4×4 up to 32×32 luma samples.

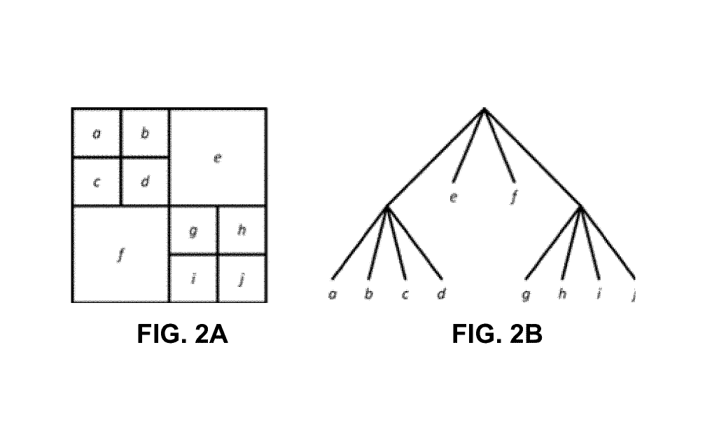

FIGS. 2A and 2B show an example where a CU includes 10 TUs, labeled with the letters a to j, and the corresponding block partitioning. Each node of the RQT is actually a transform unit (TU). The individual TUs are processed in depth-first tree traversal order, which is illustrated in the figure as alphabetical order, which follows a recursive Z-scan with depth-first traversal. The quadtree approach enables the adaptation of the transform to the varying space-frequency characteristics of the residual signal. Typically, larger transform block sizes, which have larger spatial support, provide better frequency resolution. However, smaller transform block sizes, which have smaller spatial support, provide better spatial resolution. The trade-off between the two, spatial and frequency resolutions, is chosen by the encoder mode decision, for example, based on rate-distortion optimization technique. The rate-distortion optimization technique calculates a weighted sum of coding bits and reconstruction distortion, i.e., the rate-distortion cost, for each coding mode (e.g., a specific RQT splitting structure), and selects the coding mode with least rate-distortion cost as the best mode.

Three parameters are defined in the RQT: the maximum depth of the tree, the minimum allowed transform size and the maximum allowed transform size. In HEVC, the minimum and maximum transform sizes can vary within the range from 4×4 to 32×32 samples, which correspond to the supported block transforms mentioned in the previous paragraph. The maximum allowed depth of the RQT restricts the number of TUs. A maximum depth equal to zero means that a CTU cannot be split any further if each included TU reaches the maximum allowed transform size, e.g., 32×32.

All these parameters interact and influence the RQT structure. Consider a case, in which the root CTU size is 64×64, the maximum depth is equal to zero and the maximum transform size is equal to 32×32. In this case, the CTU has to be partitioned at least once, since otherwise it would lead to a 64×64 transform block (TB), which is not allowed. The RQT parameters, i.e. maximum RQT depth, minimum and maximum transform size, are transmitted in the bitstream at the sequence parameter set (SPS) level. Regarding the RQT depth, different values can be specified and signaled for intra and inter coded CUs.

The quadtree transform is applied for both Intra and Inter residual blocks. Typically, the DCT-II transform of the same size of the current residual quadtree partition is applied for a residual block. However, if the current residual quadtree block is 4×4 and is generated by Intra prediction, the above 4×4 DST-VII transform is applied.

In HEVC, larger size transforms, e.g., 64×64 transform, are not adopted mainly due to limited benefit considering and relatively high complexity for relatively smaller resolution videos.

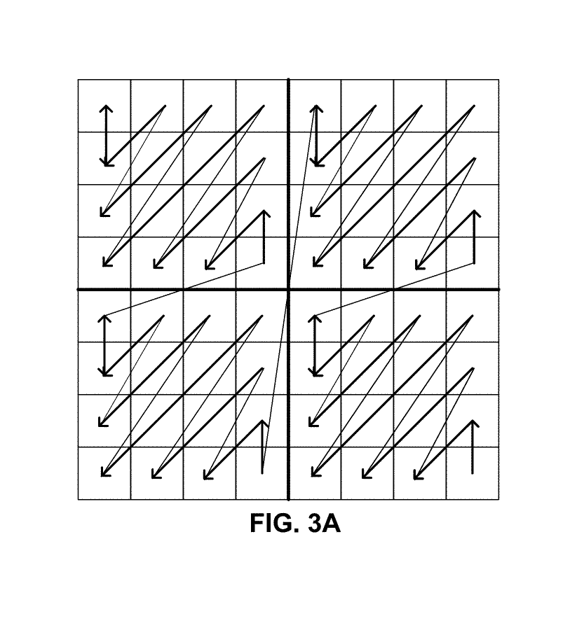

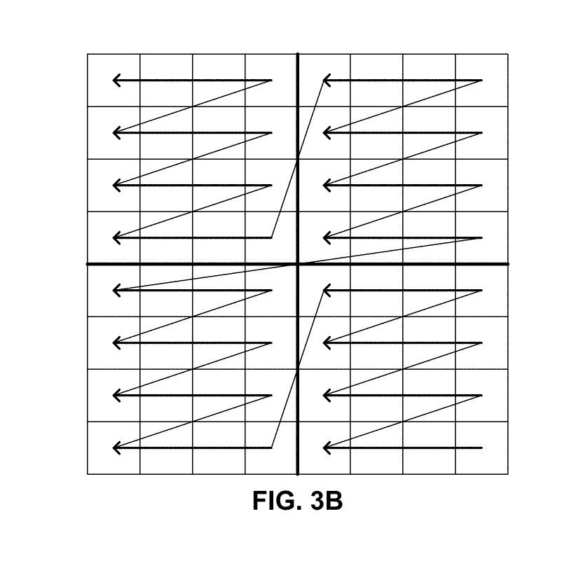

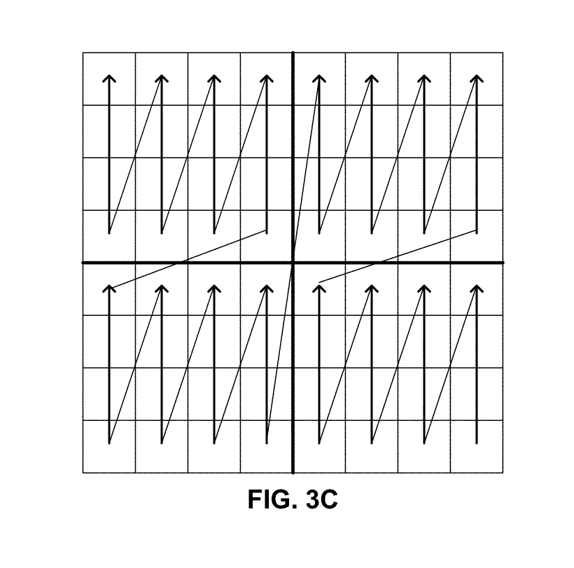

Transform coefficient coding in HEVC is described. Regardless of the TU size, the residual of the transform unit is coded with non-overlapped coefficient groups (CG), each of which contains the coefficients of a 4×4 block of a TU. For example, a 32×32 TU has totally 64 CGs, and a 16×16 TU has totally 16 CGs. The CGs inside a TU are coded according to a certain pre-defined scan order. When coding each CG, the coefficients inside the current CG are scanned and coded according to a certain pre-defined scan order for 4×4 block. FIGS. 3A-3C illustrate different examples of coefficient scans for an 8×8 TU containing 4 CGs.

A tool in HEVC that improves coding efficiency is Mode dependent coefficient scanning (MDCS), described in Y. Zheng, M. Coban, X. Wang, J. Sole, R. Joshi, and M. Karczewicz, CE11: Mode Dependent Coefficient Scanning, JCTVC-D393, 4th Joint Collaborative Team on Video Coding (JCT-VC) Meeting, Daegu, Korea, January 2011. In HEVC, the scan in a 4×4 TB (e.g., transform block but not limited to transform block) is diagonal. The scan in a larger TB is divided into 4×4 subblocks and the scan pattern consists of a diagonal scan of the 4×4 subblocks and a diagonal scan within each of the 4×4 subblocks. This is possible because in HEVC, the dimensions of all TBs are a multiple of 4.

Horizontal and vertical scans may also be applied in the intra case for 4×4 and 8×8 TBs. The horizontal and vertical scans are defined by row-by-row and column-by-column scans, respectively, within the 4×4 subblocks. The scan over the 4×4 subblocks is the same as that used within the subblock.

As an example of MDCS, for intra coded blocks, the scanning order of a 4×4 TB and a 8×8 luma TB is determined by the intra prediction mode. Each of the 35 intra modes uses one of the three possible scanning patterns: diagonal, horizontal, or vertical. A look-up table maps the intra prediction mode to one of the scans. This MDCS tool exploits the horizontal or vertical correlation of the residual depending on the intra prediction mode. For example, for a horizontal prediction mode, transform coefficient energy is clustered in the first few columns, so a vertical scan results in fewer bins being entropy coded. Similarly for a vertical prediction, a horizontal scan is beneficial. Experiments showed that including horizontal and vertical scans for large TBs offers little compression efficiency, so the application of these scans is limited to the two smaller TBs.

Context modeling of CG flag is described. When coding whether one CG has non-zero coefficients, i.e., the CG flag (coded_sub_block_flag in the HEVC specification), the information of neighboring CGs is utilized to build the context. To be more specific, the context selection for coding the CG flag is defined as: (Right CG available && Flag of right CG is equal to 1)∥(below CG available && Flag of below CG is equal to 1).

Here, the right and below CG are the two neighboring CGs close to a current CG. For example, in FIGS. 3A-3C, when coding the top-left 4×4 block, the right CG is defined as the top-right 4×4 block and the below CG is defined as the left-below 4×4 block.

Note that Chroma and luma use different sets of context models but with the same rule to select one of them. Details of the derivation of context index increment could be found in 9.3.4.2.4 of HEVC specification: JCTVC-L1003 v34, http://phenix.it-sudparis.eu/jct/doc_end_user/documents/12_Geneva/wg11/JCTVC-L1003-v34.zip. The JCTVC-L1003_v34 is referred to HEVC specification reference herein.

Transform coefficient coding within one CG is described. For those CGs that may contain non-zero coefficients, significant flags (significant_flag), absolute values of coefficients (including coeff_abs_level_greater1_flag, coeff_abs_level_greater2_flag and coeff_abs_level_remaining) and sign information (coeff_sign_flag) may be further coded for each coefficient according to the pre-defined 4×4 coefficient scan order. The coding of transform coefficient levels is separated into multiple scan passes.

1) First pass of the first bin coding: In this pass, all the first bins (or the bin index 0, bin0) of transform coefficients at each position within one CG are coded except that it could be derived that the specific transform coefficient is equal to 0. The variable sigCtx depends on the current location relative to the top-left postion of current TU, the color component index cIdx, the transform block size, and previously decoded bins of the syntax element coded_sub_block_flag. Different rules may be applied depending on the TU size. Details of the selection of the context index increment is defined in 9.3.4.2.5 of HEVC reference specification.

2) Second pass of the second bin coding: The coding of coeff_abs_level_greater1_flags is applied in this pass. The context modeling is dependent on color component index, the current sub-block scan index, and the current coefficient scan index within the current sub-block. Details of the selection of the context index increment are defined in 9.3.4.2.6 of HEVC reference specification.

3) Third pass of the third bin coding: The coding of coeff_abs_level_greater2_flags is applied in this pass. The context modeling is similar to that used by coeff_abs_level_greater1_flags. Details of the selection of the context index increment is defined in 9.3.4.2.7 of HEVC reference specification.

Note that in order to improve throughput, the second and third passes may not process all the coefficients in a CG. The first eight coeff_abs_level_greater1_flags in a CG are coded in regular mode. After that, the values are left to be coded in bypass mode in the fifth pass by the syntax coeff_abs_level_remaining. Similarly, only the coeff_abs_level_greater2_flags for the first coefficient in a CG with magnitude larger than 1 are coded. The rest of coefficients with magnitude larger than 1 of the CG use coeff_abs_level_remaining to code the value. This method may limit the number of regular bins for coefficient levels to a maximum of 9 per CG: 8 for the coeff_abs_level_greater1_flags and 1 for coeff_abs_level_greater2_flags.

4) Fourth pass of sign information: In HEVC, the sign of each nonzero coefficient is coded in the fourth scan pass in bypass mode. For each CG, and depending on a criterion, encoding the sign of the last nonzero coefficient (in reverse scan order) is simply omitted when using sign data hidding (SDH). Instead, the sign value is embedded in the parity of the sum of the levels of the CG using a predefined convention: even corresponds to “+” and odd to “−.” The criterion to use SDH is the distance in scan order between the first and the last nonzero coefficients of the CG. If this distance is equal or larger than 4, SDH is used. If the distance is less than 4, SDH is not used. This value of 4 was chosen because it provides the largest gain on HEVC test sequences.

5) Last pass of remaining bins: The remaining bins are coded in a further scan pass. Let the baseLevel of a coefficient be defined as: baseLevel=significant_flag+coeff_abs_level_greater1_flag+coeff_abs_level_greater2_flag, where a flag has a value of 0 or 1 and is inferred to be 0 if not present. Then, the absolute value of the coefficient is simply absCoeffLevel=baseLevel+coeff_abs_level_remaining.

The Rice parameter is set to 0 at the beginning of each CG and it is conditionally updated depending on the previous value of the parameter and the current absolute level as follows: if absCoeffLevel>3×2 m, m=min(4,m+1).

The syntax element coeff_abs_level_remaining is coded in bypass mode. In addition, HEVC employs Golomb-Rice codes for small values and switches to an Exp-Golomb code for larger values. The transition point between the codes is when the unary code length equals 4. The parameter update process allows the binarization to adapt to the coefficient statistics when large values are observed in the distribution.

Sign data hiding is described. For each CG, and depending on a criterion, encoding the sign of the last nonzero coefficient (in reverse scan order) is simply omitted when using sign data hiding (SDH). Instead, the sign value is embedded in the parity of the sum of the levels of the CG using a predefined convention: even corresponds to “+” and odd to “−.” The criterion to use SDH is the distance in scan order between the first and the last nonzero coefficients of the CG. If this distance is equal or larger than 4, SDH may be used.

In US Patent Publication Nos. 2016/0353111 A1, 2016/0353112 A1, and 2016/0353113 A1, and U.S. Provisional Ser. No. 62/168,571, there is description of techniques to further modify the CG sizes based on transform size. In some examples, CG size may be dependent on coding mode. In other examples, CG size may be dependent on transform matrix.

The following describes coding structures beyond HEVC, such as quad-tree-binary-tree (QTBT) structure in JEM. In VCEG proposal COM16-C966 (D. Marpe, H. Schwarz, and T. Wiegand, “Context-based adaptive binary arithmetic coding in the H.264/AVC video compression standard,” IEEE Trans. Circuits Syst. Video Technol., vol. 13, no. 7, pp. 620-636, July 2003), a quad-tree-binary-tree (QTBT) was proposed for future video coding standard beyond HEVC. Simulations showed the proposed QTBT structure is more efficient than quad-tree structure in used HEVC.

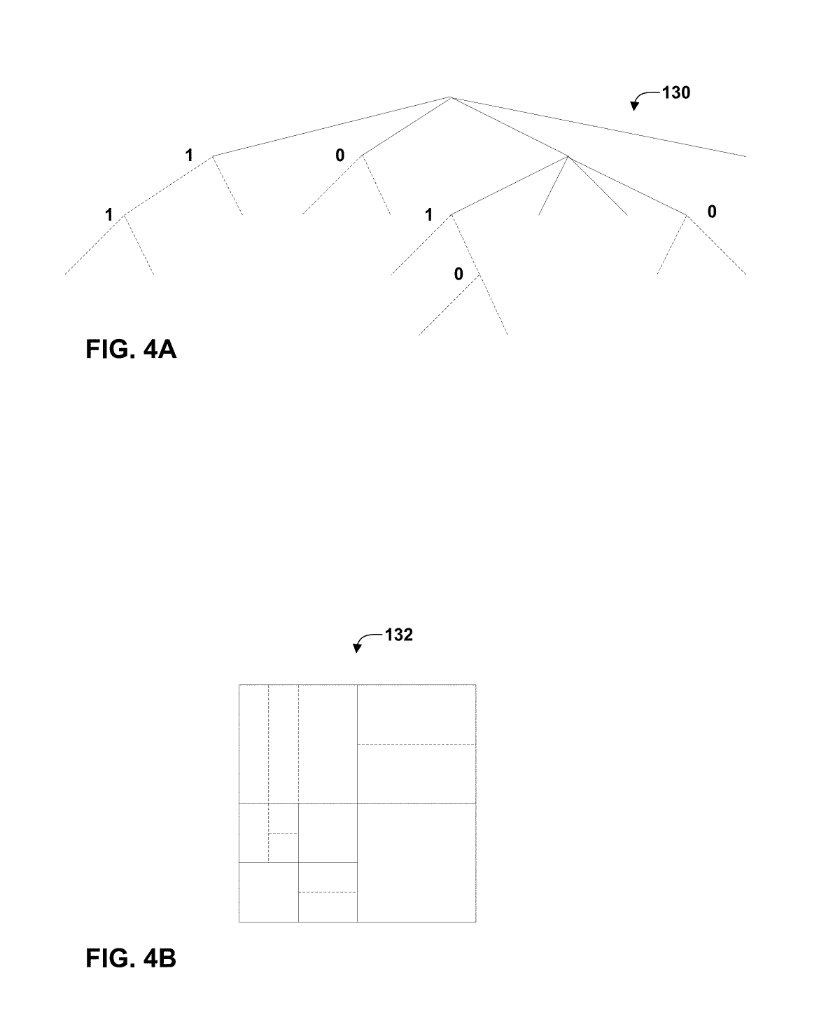

In the proposed QTBT structure, described with respect to FIGS. 4A and 4B, a CTB is firstly partitioned by quad-tree, where the quad-tree splitting of one node can be iterated until the node reaches the minimum allowed quad-tree leaf node size (MinQTSize). If the quad-tree leaf node size is not larger than the maximum allowed binary tree root node size (MaxBTSize), it can be further partitioned by a binary tree. The binary tree splitting of one node can be iterated until the node reaches the minimum allowed binary tree leaf node size (MinBTSize) or the maximum allowed binary tree depth (MaxBTDepth). The binary tree leaf node is namely CU which may be used for prediction (e.g. intra-picture or inter-picture prediction) and transform without any further partitioning).

There are two splitting types, symmetric horizontal splitting and symmetric vertical splitting, in the binary tree splitting. In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad--tree leaf nodes. The quad-tree leaf nodes may have a size from 16×16 (i.e., the MinQTSize) to 128×128 (i.e., the CTU size). If the leaf quad-tree node is 128×128, it may not be further split by the binary tree since the size exceeds the MaxBTSize (i.e., 64×64). Otherwise, the leaf quad-tree node may be further partitioned by the binary tree. Therefore the quad-tree leaf node is also the root node for the binary tree and has the binary tree depth as 0. When the binary tree depth reaches MaxBTDepth (i.e., 4), it implies that there is no further splitting. When the binary tree node has width equal to MinBTSize (i.e., 4), it implies no further horizontal splitting. Similarly, when the binary tree node has height equal to MinBTSize, it implies no further vertical splitting. The leaf nodes of the binary tree are namely CUs further processed by prediction and transform without any further partitioning.

FIGS. 4A and 4B are conceptual diagram illustrating an example quadtree binary tree (QTBT) structure 130, and a corresponding coding tree unit (CTU) 132. FIG. 4B illustrates an example of block partitioning by using QTBT, and FIG. 4A illustrates the corresponding tree structure. The solid lines indicate quad-tree splitting and dotted lines indicate binary tree splitting. In each splitting (i.e., non-leaf) node of the binary tree, one flag is signaled to indicate which splitting type (i.e., horizontal or vertical) is used, where 0 indicates horizontal splitting and 1 indicates vertical splitting. For the quad-tree splitting, there is no need to indicate the splitting type since it always split a block horizontally and vertically into 4 sub-blocks with an equal size.

In QTBT, the concept of CU/PU/TU is aligned wherein CU may be always equal to PU and TU. In QTBT, CG size is set to 2×2 (if either width or height of a CU is equal to 2) and 4×4 (otherwise).

In FIGS. 4A and 4B, the solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 4B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

A decoupled tree structure, such as QTBT or triple tree, is now described. In addition, the QTBT block structure supports the feature that luma and chroma have the separate QTBT structure. Currently, for P and B slices, the luma and chroma CTUs in one CTU share the same QTBT structure. For an I slice, the luma CTU is partitioned into CUs by a QTBT structure, and the chroma CTU is partitioned into chroma CUs by another QTBT structure. This means that a CU in an I slice consists of a coding block of luma component or coding blocks of two chroma components, and a CU in P and B slices include coding blocks of all three color components.

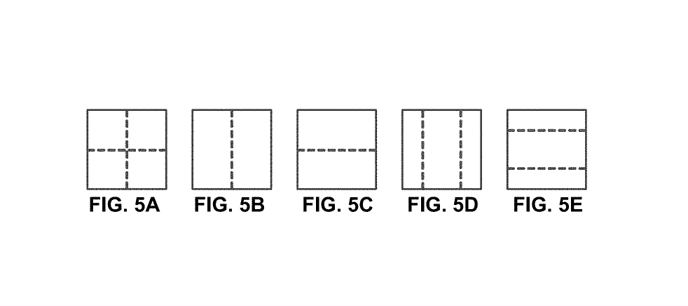

Triple tree is described. In JVET-D0117: Li et. at. “Multi-Type-Tree,” JEVT of ITU-T SG 16 WP 3 and ISO/IEC JTC 1/SC 29/WG 11 4^{th} Meeting: Chengdu, C N, 15-21 Oct. 2016, a triple tree structure is introduced. A CTU is partitioned with RT (quad-tree). A RT (region tree) leaf may be further split with a prediction tree (PT, which could be a binary tree (BT) or a triple tree(TT)). A PT leaf may also be further split with PT until max PT depth is reached. A PT leaf is the basic coding unit (CU) which cannot be further split. For the vertical/horizontal binary tree (BT): W/H= 1/2 or 2; for Vertical/horizontal triple tree (TT): W/H=1/4, ½, 2, or 4. FIGS. 5A-5E show examples of QT, BT and TT.

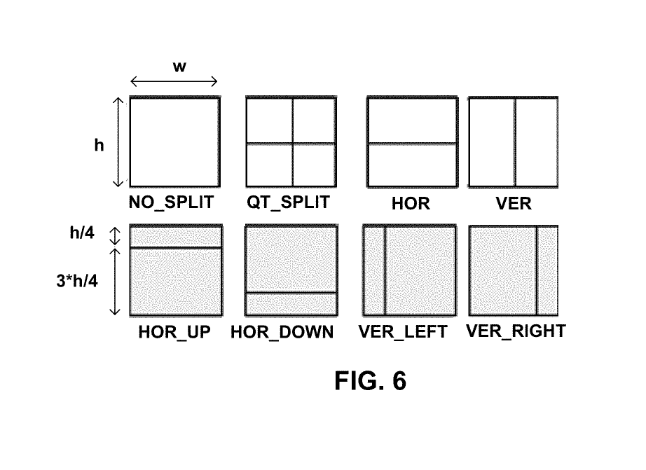

A non-symmetric tree is now described. In JVET-D0064: Leannec et. at. “Asymmetric Coding units in QTBT,” JEVT of ITU-T SG 16 WP 3 and ISO/IEC JTC 1/SC 29/WG 11 4^{th} Meeting: Chengdu, CN, 15-21 Oct. 2016, a triple tree structure is introduced. 4 new Binary Tree Split modes: HOR_UP, HOR_DOWN, VER_LEFT, VER_RIGHT on top of QTBT are added, as depicted in the bottom part of FIG. 6. For the newly introduced partition types, whenever a width or height of a CU is not a multiple of 4, such as (6×N or N×6), the CG size is set to 2×2. Only diagonal scan may be utilized for non-square blocks.

There may be the following technical problems in the entropy coding part of HEVC or JEM. MDCS was developed under the assumption that each TU is a square block. In other words, for non-square blocks, diagonal scan is always used. How to handle the non-square blocks is unknown.

In some techniques, whenever there is a CG with size equal to 2×2 (due to either width or height of a block is not a multiple of 4), the sign data hiding is prohibited which may result in worse coding performance.

Fixed CG size (as a square block) is utilized for a given coding block which may not be able to capture local residual characteristics and different block types.

Example technical solutions to the technical problems described above are described with the following methods for MDCS and CG design for non-square blocks. The following techniques may be applied individually or in any combination.

In one or more example techniques described in this disclosure, there may be multiple coding group (CG) sizes within one block. In one or more example technique described in this disclosure, non-square CG sizes may be utilized. For example, as described above, as part of video encoding, video encoder 200 may determine residual samples of a residual block based on a difference between a current block and a prediction block. Video encoder 200 may then transform the residual samples of the residual block into a block of coefficient values.

The current block that is being encoded (and then later decoded by video decoder 300) may have a width or height that is not a multiple of 4. For instance, the current block may be based on (e.g., a result of) one of a quad-tree-binary-tree (QTBT) partitioning or a triple tree partitioning. Accordingly, in some examples, the current block may be non-square.

In one or more examples, video encoder 200 may partition the block of coefficient values into one or more non-square coefficient groups (CGs). The one or more non-square CGs together form at least part of the block of coefficient values, and the coefficient values for the one or more non-square CGs form at least part of the coefficient values for the block of coefficient values. In this way, a non-square CG size may be utilized. In one example, for a block of coefficient values with size equal to 6×N or N×6, the CGs may be formed as 3×N/2 or N/2×3 or 2×N/2 or 2×N sized coefficient values.

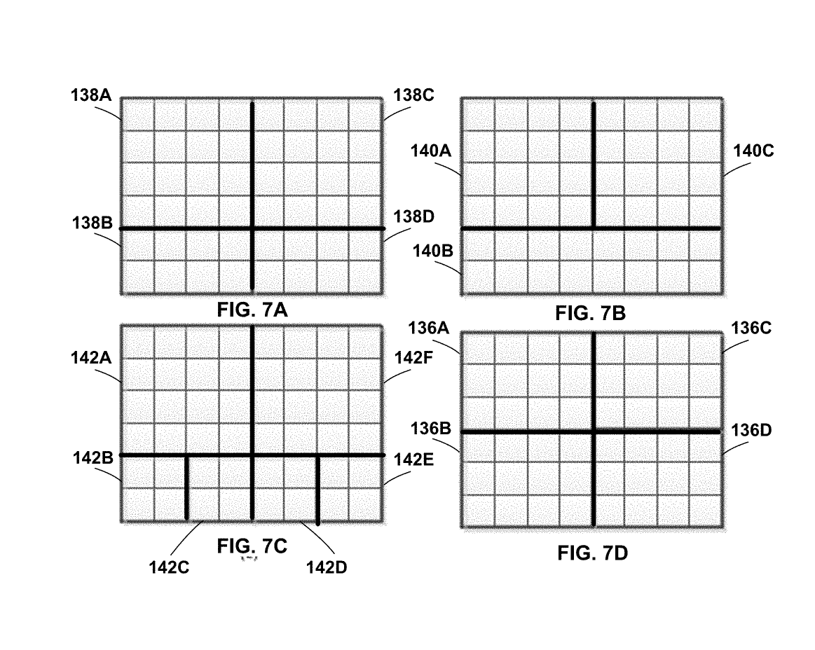

FIG. 7D gives an example for 6×8 block. As illustrated in FIG. 7D, there is a 6×8 block of coefficient values. In FIG. 7D, the block of coefficient values is partitioned into CGs 136A-136D. As illustrated, each one of CGs 136A-136D is of size 3×4 (e.g., a non-square block that is of size 3×N/2, where N is 8). In one or more examples, video encoder 200 may determine information indicative of the coefficient values in each of CGs 136A-136D. For instance, video encoder 200 may scan the coefficient values of CGs 136A-136D using a vertical, horizontal, or diagonal scan, and scan among CGs 136A-136D vertically, horizontally, or diagonally (e.g., start with CG 136D, then CG 136C, then CG 136B, and then CG 136A for a diagonal scan among CGs 136A-136D), and determine information indicative of the coefficient values as described above. Video encoder 200 may signal the information indicative of the coefficient values to video decoder 300, and video decoder 300 may in turn determine, for a current block, coefficient values for one or more non-square CGs 136A-136D.

As illustrated in FIG. 7D, non-square CGs 136A-136D together form at least a part of the block of coefficient values, and in the example, together form the entirety of the block of coefficient values. The coefficient values for CGs 136A-136D form at least part of the coefficient values for the block of coefficient values of FIG. 7D.

In the example illustrated in FIG. 7D, non-square CGs 136A-136D are all the same size. The example techniques described in this disclosure are not so limited. In some examples, the CGs of a block of coefficient values include a first non-square CG and a second non-square CG, where a size of the first non-square CG and a size of the second non-square CG is different.

In one example, for a block of coefficient values with size equal to 6×N, 4×4 and 2×4 sized CGs may be both utilized. Similarly, for a block of coefficient values with size equal to N×6, 4×4 and 4×2 sized CGs may be both utilized.

FIG. 7A gives an example for 6×8 block. FIG. 7A includes CGs 138A-138D. CGs 138 and 138C are square CGs (e.g., 4×4), and CGs 138B and 138D are non-square CGs (e.g., 2×4). Accordingly, in FIG. 7A, non-square CGs 138B and 138D form a first part of the block of coefficient values and include a first part of the coefficient values of the block of coefficient values, and square CGs 138A and 138C form a second part of the block of coefficient values and include a second part of the coefficient values of the block of coefficient values.

In one example, for a block of coefficient values with size equal to 6×N, 4×4 and 2×N sized CGs may be both utilized. Similarly, for a block of coefficient values with size equal to N×6, 4×4 and N×2 sized CGs may be both utilized.

FIG. 7B gives an example for 6×8 block. FIG. 7B includes CGs 140A-140C. CGs 140A and 140C are square CGs (e.g., 4×4), and CG 140B is a non-square CG (e.g., 2×N, where N is equal to 8). Accordingly, in FIG. 7B, non-square CG 140B forms a first part of the block of coefficient values and includes a first part of the coefficient values of the block of coefficient values, and square CGs 140A and 140C form a second part of the block of coefficient values and include a second part of the coefficient values of the block of coefficient values.

In one example, for a block of coefficient values with size equal to 6×N or N×6, 4×4 and 2×2 sized CGs may be both utilized. FIG. 7C gives an example for a 6×8 block. In FIG. 7C, the block of coefficient values includes CGs 142A-142F. In this example, CGs 142A and 142F are the same size and CGs 142B-142E are the same size. In this manner, there may be different sized CGs within a block of coefficient values.

FIGS. 7A-7D provide some examples of non-square CGs. As another example, a current block, predicted in intra prediction such as intra sub-partitioning, may have a size of 8×16. This 8×16 block may be partitioned into four 2×16 blocks. In one example, there may be two CGs used for each of the four 2×16 blocks. The size of each of the two CGs may be 2×8.

In one example, a block of coefficient values can be partitioned into CGs in different ways as shown in FIGS. 7A-7D. The partition method can be signaled. For example, code “00” corresponds to partitioning shown in FIG. 7A; code “01” corresponds to partitioning shown in FIG. 7B; code “10” corresponds to partitioning shown in FIG. 7C; and code “11” corresponds to partitioning shown in FIG. 7D. This code can be signaled at SPS, PPS, VPS, slice header, CTU level, and/or block level.

For example, video encoder 200 may signal information indicative of a manner in which the block of coefficient values is partitioned into CGs (e.g., using 00, 01, 10, and 11 code scheme as one non-limiting example). Video decoder 300 may receive the information indicative of a manner in which the block of coefficient values is partitioned in CGs. Video decoder 300 may determine, for the current block being decoded, the coefficient values based on the manner in which the block of coefficient values is partitioned.

For instance, video decoder 300 may utilize the received information indicative of a manner in which the block of coefficient value is partitioned to determine the number, size, and location of the CGs within the block of coefficient values. Video decoder 300 may receive signaling information, or determine using implicit techniques that do not require signaling information, indicative of a scan order among the CGs (e.g., which CG is scanned first, second, third, and so on) and within the CGs (e.g., the order in which the coefficient values within the CGs are scanned). After decoding the information indicative of a coefficient value, video decoder 300 may determine to which location in the block of coefficient values the coefficient value belongs based on the manner in which the block of coefficient value is partitioned and the scan order.

Using FIG. 7D as an example, video decoder 300 may receive an 11 code value meaning that the block of coefficient values is partitioned according to the partitioning of FIG. 7D. Video decoder 300 may also determine information indicative of the scan order among CGs 136A-136D and within CGs 136A-136D (e.g., based on signaling from video encoder 200 or based on characteristics of the current block). For instance, assume that a diagonal scan within CGs 136A-136D and among CGs 136A-136D is used. In this example, video decoder 300 may determine the location of the first coefficient value that video decoder 300 determines based on the diagonal scan being used within CGs 136A-136D and among CGs 136A-136D.

In some examples, the techniques of this disclosure may be only applied to a certain color component (such as Y or G component), and/or certain block shapes and/or block sizes. For example, video decoder 300 may determine that the current block is of a particular color component. In such examples, to determine, for the current block, the coefficient values for one or more non-square coefficient groups, video decoder 300 may be configured to determine, for the current block, the coefficient values for one or more non-square coefficient groups, responsive to the current block being of the particular color component.

Video decoder 300 may determine that the current block is of a particular block shape (e.g., non-square). To determine, for the current block, the coefficient values for one or more non-square coefficient groups, video decoder 300 may be configured to determine, for the current block, the coefficient values for one or more non-square coefficient groups, responsive to the current block being of the particular block shape.

Video decoder 300 may determine that the current block is of a particular size. To determine, for the current block, the coefficient values for one or more non-square coefficient groups, video decoder 300 may be configured to determine, for the current block, the coefficient values for one or more non-square coefficient groups, responsive to the current block being of the particular size.

Video encoder 200 may determine that the current block is of a particular color component. To partition the block of coefficient values into the one or more non-square coefficient groups, video encoder 200 may be configured to partition the block of coefficient values into the one or more non-square coefficient groups, responsive to the current block being of the particular color component.

Video encoder 200 may determine that the current block is of a particular block shape (e.g., non-square). To partition the block of coefficient values into the one or more non-square coefficient groups, video encoder 200 may be configured to partition the block of coefficient values into the one or more non-square coefficient groups, responsive to the current block being of the particular block shape.

Video encoder 200 may determine that the current block is of a particular size. To partition the block of coefficient values into the one or more non-square coefficient groups, video encoder 200 may be configured to partition the block of coefficient values into the one or more non-square coefficient groups, responsive to the current block being of the particular size.

The above described examples with respect to CGs. The following describes examples with respect to MDCS. For instance, for a non-square block (e.g., where the current block being coded is not a square block due to QTBT or triple tree partitioning), multiple scan patterns may be used (e.g., not only diagonal scan).

For example, for a non-square block, video encoder 200 and video decoder 300 may utilize MDCS (e.g., for a non-square block, MDCS may also be applied). In one example, whenever a block width or height is not larger than a threshold (e.g., less than or equal to the threshold), MDCS may be enabled. In some examples, whenever a block width or height is smaller than a threshold (e.g., just less than the threshold), MDCS may be enabled. For example, video encoder 200 may compare the width or height of the current block to a threshold value, and determine whether MDCS is enabled based on the comparison. Video decoder 300 may determine whether MDCS is going to be available based on a similar comparison (e.g., compare height and width to a threshold). Based on the determination of whether MDCS is going to be available, video decoder 300 may determine that certain syntax elements are to be retrieved from the bitstream.

In one example, one threshold may be used for all kinds of coded blocks, such as 8. In some examples, multiple thresholds may be used. In one example, the thresholds may depend on whether the block is square, or non-square. In another example, the thresholds may depend on the ratio between width and height of the block. In another example, the thresholds may depend on whether the component is Y, or Cb/Cr. In one example, the threshold(s) may be pre-defined or signaled, such as in SPS, PPS, VPS, slice header, CTU level, and/or block level.

In one example, square or non-square blocks may share the same look-up table which defines the relationship between scan pattern and intra prediction modes. For example, in MDCS, the scan pattern may be a function of the intra prediction mode. Video encoder 200 may access the same look-up table to determine the scan pattern for an intra-predicted block, in accordance with MDCS, regardless of whether the intra-predicted block is a square block or a non-square block. Similarly, video decoder 300 may access the same look-up table to determine the scan pattern for an intra-predicted block, in accordance with MDCS, regardless of whether the intra-predicted block is a square block or a non-square block.

In some examples, square or non-square blocks may utilize different look-up tables which defines the relationship between scan pattern and intra prediction modes. For example, video encoder 200 and video decoder 30 may each utilize a first look-up table that defines a relationship between scan patterns and intra prediction modes for non-square blocks and utilize a second, different look-up table that defines a relationship between scan patterns and intra prediction modes for square blocks.

In some examples, look-up tables which defines the relationship between scan pattern and intra prediction modes may depend on the block sizes and/or shapes. For example, 16×8 blocks and 8×16 blocks may have different look-up tables.

The techniques described in this disclosure may be also applied to other kinds of scan pattern derivation methods which may not depend on the intra prediction modes. The same rule for scan pattern derivation method for square and non-square blocks may be applied. In some examples, different rules for square and non-square blocks (or different ratio of block width and height) may be applied.

MDCS or other kinds of multiple scan patterns methods may also be applied with different rules on different components. For example, a Cb/Cr block may be coded with LM (linear model) mode. Such a block may be scanned in a special order that is not used by a Y block. In another example, the scanning order for a Cb/Cr block coded with LM mode (or other cross-component linear model prediction mode like MMLM in JEM) is the same as the scanning order of a predefined mode, like Planar or DC.

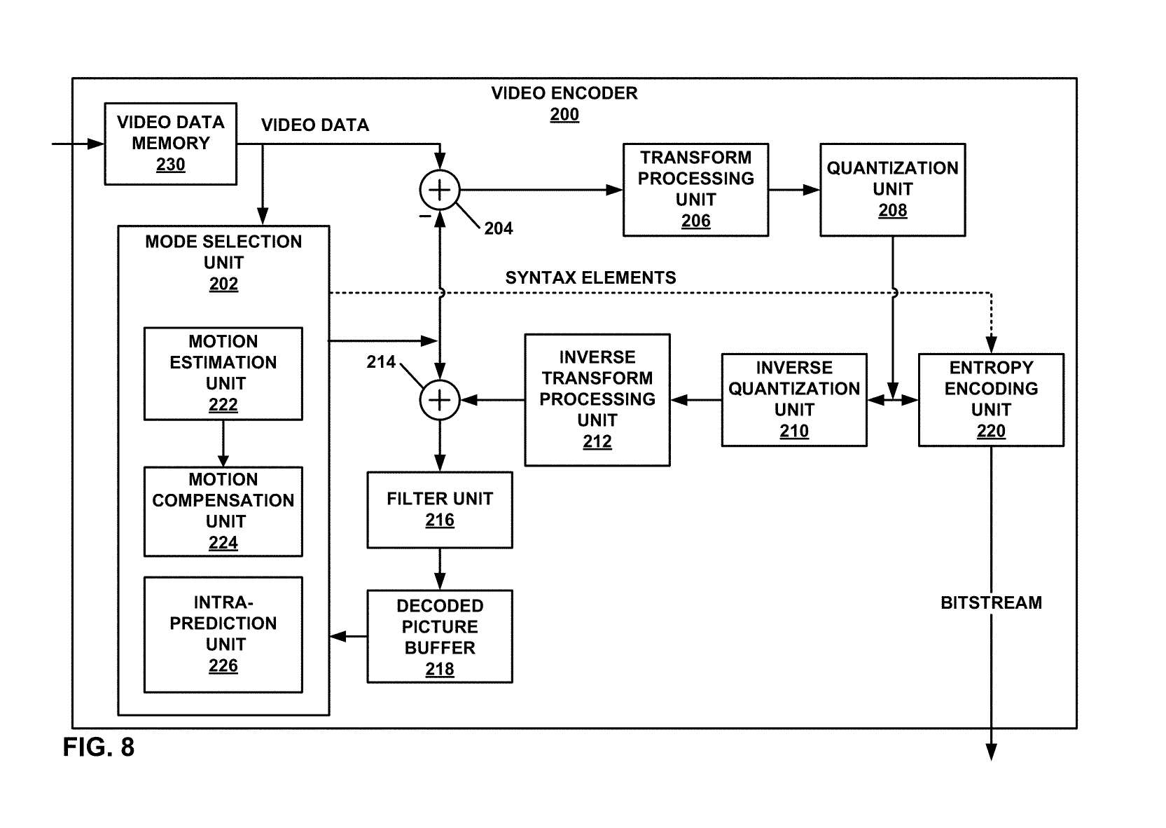

FIG. 8 is a block diagram illustrating an example video encoder 200 that may perform the techniques of this disclosure. FIG. 8 is provided for purposes of explanation and should not be considered limiting of the techniques as broadly exemplified and described in this disclosure. For purposes of explanation, this disclosure describes video encoder 200 in the context of video coding standards such as the H.265 HEVC video coding standard and the H.266 (VVC) video coding standard in development. However, the techniques of this disclosure are not limited to these video coding standards and are applicable generally to video encoding and decoding.

In the example of FIG. 8, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 8 are illustrated to assist with understanding the operations performed by video encoder 200. The units may be implemented as fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, linear model (LM) mode coding, 360-degree video coding as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block” or “transform block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 is an example of at least one of programmable or fixed-function circuitry that is configured to perform the example techniques described in this disclosure. For example, residual generation unit 204 may determine residual samples of a residual block based on a difference between a current block (e.g., a current block that is non-square) and a prediction block. The prediction block is stored in DPB 218, as an example. In some examples, a width or height of the current block is not a multiple of 4. In some examples, the current block is generated based on a QTBT or triple tree portioning, and therefore may be non-square shaped. For example, mode selection unit 202 may generate the current block based on a QTBT partitioning or a triple tree partitioning.

Transform processing unit 206 may transform the residual sample of the residual block into a block of coefficient values (e.g., by applying a DCT or DST transform). In some examples, mode selection unit 202, transform processing unit 206, and/or entropy encoding unit 220 may be configured to partition the block of coefficient values into one or more non-square coefficient groups (CGs). The one or more non-square coefficient groups together form at least part of the block of coefficient values, and coefficient values for the one or more non-square coefficient groups form at least a part of the coefficient values for the block of coefficient values. Entropy encoding unit 220 may signal information indicative of the coefficient values for the one or more square coefficient groups.

As one example, to partition the block of coefficient values into the one or more non-square coefficient groups, video encoder 200 (e.g., via mode selection unit 202, transform processing unit 206, or entropy encoding unit 220) partitions the block of coefficient values into a first non-square CG and partitions the block of coefficient values into a second non-square CG, where a size of the first non-square CG and a size of the second non-square CG are different.

As one example, the one or more non-square coefficient groups form a first part of the block of coefficient values. Video encoder 200 (e.g., via mode selection unit 202, transform processing unit 206, or entropy encoding unit 220) partition the block of coefficient values into the one or more square coefficient groups. The one or more square coefficient groups together form a second part of the block of coefficient values. Therefore, it may be possible for the block of coefficient values to include both non-square CGs and square CGs.

In the above examples, there may be various ways in which to partition the block of coefficient values into one or more CGs. In some examples, video encoder 200 (e.g., via entropy encoding unit 220) may signal information indicative of a manner in which the block of coefficient values is partitioned.

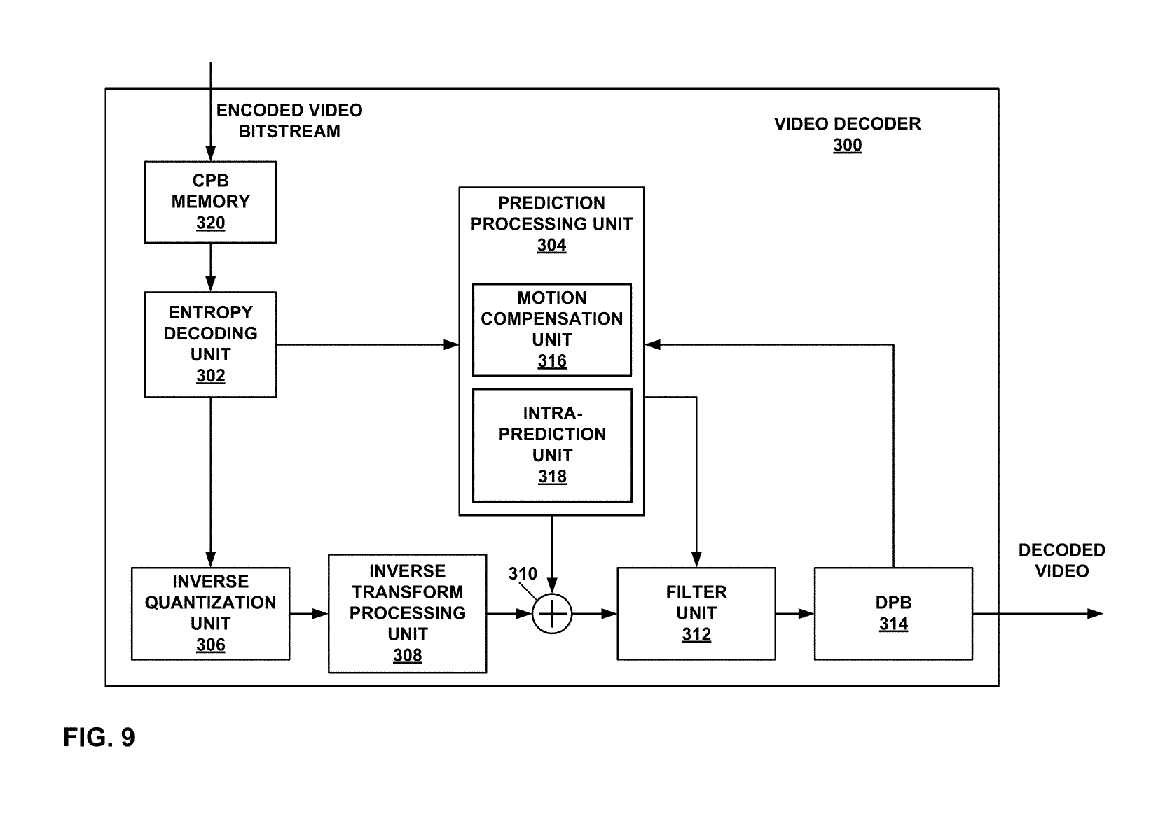

FIG. 9 is a block diagram illustrating an example video decoder 300 that may perform the techniques of this disclosure. FIG. 9 is provided for purposes of explanation and is not limiting on the techniques as broadly exemplified and described in this disclosure. For purposes of explanation, this disclosure describes video decoder 300 is described according to the techniques of VVC, JEM, and/or HEVC. However, the techniques of this disclosure may be performed by video coding devices that are configured to other video coding standards.

In the example of FIG. 9, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, a 360-degree video decoding unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 9 are illustrated to assist with understanding the operations performed by video decoder 300. The units may be implemented as fixed-function circuits, programmable circuits, or a combination thereof. Similar to FIG. 8, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed- function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 8).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 8). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

Video decoder 300 is an example of at least one of programmable or fixed-function circuitry that is configured to perform the example techniques described in this disclosure. For example, entropy decoding unit 302 (possibly along with inverse quantization unit 306) may determine, for a current block (e.g., a current block that is non-square) that is being decoded, coefficient values for one or more non-square coefficient groups (CGs). The one or more non-square CGs together form at least part of a block of coefficient values, and the coefficient values for the one or more non-square CGs form at least a part of the coefficient values for the block of coefficient value. In some examples, a width or height of the current block is not a multiple of 4. In some examples, the current block is based on one of a QTBT partitioning or triple tree partitioning, and therefore, may be non-square shaped.

Inverse transform processing unit 308 may transform the coefficient values of the coefficient block into residual samples of a residual block. Reconstruction unit 310 (e.g., with filter unit 312) may reconstruct the current block based on a prediction block stored in memory (e.g., DPB 314) and the residual block.

As one example, to determine the coefficient values for the one or more non-square coefficient groups, video decoder 300 (e.g., via entropy decoding unit 302, prediction processing unit 304, or inverse transform processing unit 308) may determine coefficient values for a first non-square CG of the one or more non-square coefficient groups and determine coefficient values for a second non-square CG of the one or more non-square coefficient groups. A size of the first non-square CG and a size of the second non-square CG are different.

As one example, the one or more non-square CGs form a first part of the block of coefficient values. Video decoder 300 (e.g., via entropy decoding unit 302, prediction processing unit 304, or inverse transform processing unit 308) may determine, for the current block, coefficient values for one or more square coefficient groups. The one or more square coefficient groups together form a second part of the block of coefficient values. Therefore, it may be possible for the block of coefficient values to include both non-square CGs and square CGs.

In the above examples, there may be various ways in which to partition the block of coefficient values into one or more CGs. In some examples, video decoder 300 (e.g., via entropy decoding unit 302) may receive information indicative of a manner which the block of coefficient values is partitioned. Video decoder 300 may determine, for the current block, the coefficient values for one or more non-square CGs based on the information indicative of the manner in which the block of coefficient values is partitioned.

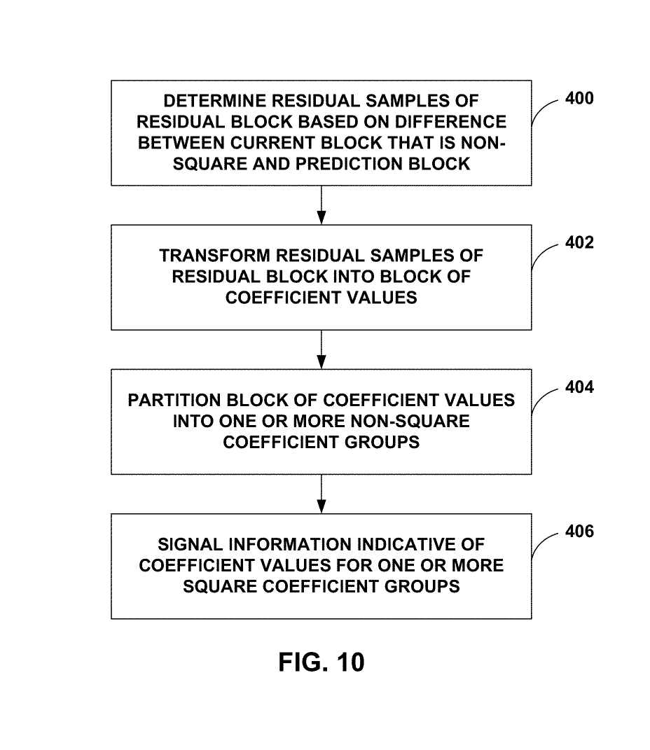

FIG. 10 is a flowchart illustrating an example method of encoding video data. For example, video encoder 200 may determine residual samples of a residual block based on a difference between a current block that is non-square and a prediction block (400). The prediction block may be stored in DPB 218. A width or height of the current block is not a multiple of 4. In some examples, video encoder 200 may generate the current block based on one of a quad-tree-binary-tree (QTBT) partitioning or a triple tree partitioning.

Video encoder 200 may transform the residual samples of the residual block into a block of coefficient values (402). For example, video encoder 200 may perform the DCT or DST to transform the residual block into a block of coefficient values.

In one or more examples, video encoder 200 may partition the block of coefficient values into one or more non-square coefficient groups (404). The one or more non-square coefficient groups together form at least part of the block of coefficient values, and coefficient values for the one or more non-square coefficient groups form at least a part of the coefficient values for the block of coefficient values.

As one example, to partition the block of coefficient values into the one or more non-square coefficient groups, video encoder 200 may partition the block of coefficient values into a first non-square coefficient group of the one or more non-square coefficient groups and partition the block of coefficient values into a second non-square coefficient group of the one or more non-square coefficient groups. A size of the first non-square coefficient group and a size of the second non-square coefficient group are different.

In some examples, the one or more non-square coefficient groups form a first part of the block of coefficient values. Video encoder 200 may partition the block of coefficient values into the one or more square coefficient groups. The one or more square coefficient groups together form a second part of the block of coefficient values.

Video encoder 200 may signal information indicative of the coefficient values for the one or more square coefficient groups (406). For example, video encoder 200 may utilize the above described techniques to signal information indicative of the coefficient values. Moreover, as described above, there may be various ways in which to partition the block of coefficient values into the one or more coefficient groups. In some examples, video encoder 200 may signal information indicative of a manner in which the block of coefficient values is partitioned.

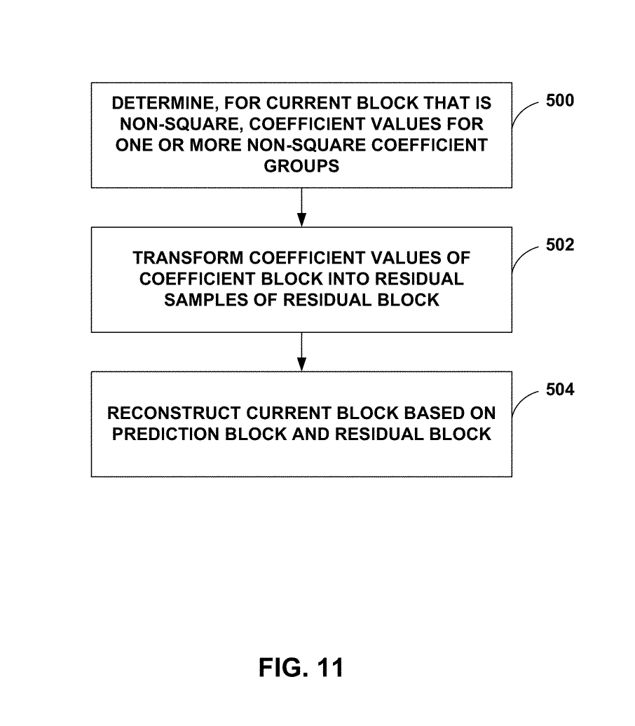

FIG. 11 is a flowchart illustrating an example method of decoding video data. For example, video decoder 300 may determine, for a current block that is non-square being decoded, coefficient values for one or more non-square coefficient groups (500). The one or more non-square coefficient groups together form at least part of a block of coefficient values, and the coefficient values for the one or more non-square coefficient groups form at least a part of the coefficient values for the block of coefficient values. A width or height of the current block may not be a multiple of 4. In some examples, the current block is based on one of a quad-tree-binary-tree (QTBT) partitioning or a triple tree partitioning.

In some examples, video decoder 300 may receive information indicative of a manner in which the block of coefficient values is partitioned. Video decoder 300 may determine, for the current block, the coefficient values for one or more non-square coefficient groups based on the information indicative of the manner in which the block of coefficient values is partitioned.

In one or more examples, to determine the coefficient values for the one or more non-square coefficient groups, video decoder 300 may determine coefficient values for a first non-square coefficient group of the one or more non-square coefficient groups and determine coefficient values for a second non-square coefficient group of the one or more non-square coefficient groups. A size of the first non-square coefficient group and a size of the second non-square coefficient group are different.

In some examples, the one or more non-square coefficient groups form a first part of the block of coefficient values. Video decoder 300 may be configured to determine, for the current block, coefficient values for one or more square coefficient groups. The one or more square coefficient groups together form a second part of the block of coefficient values.

Video decoder 300 may transform the coefficient values of the coefficient block into residual samples of a residual block (502). For example, video decoder 300 may perform the inverse of the transform (e.g., inverse DCT or DST) that video encoder 200 performed to transform the residual block into the block of coefficient values.

Video decoder 300 may reconstruct the current block based on a prediction block (e.g., stored in DPB 314) and the residual block (504). For example, video decoder 300 may add the residual block and the prediction block to reconstruct the current block. In some examples, further filtering of the current block such as with filter unit 312 may be possible.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various techniques in this disclosure have been described with reference to a video coder or video coding, which are intended to be a generic term that can refer to either a video encoder and video encoding or to a video decoder and video decoding. Unless explicitly stated otherwise, it should not be assumed that techniques described with respect to a video encoder or a video decoder cannot be performed by the other of a video encoder or a video decoder. For example, in many instances, a video decoder performs the same, or sometimes a reciprocal, coding technique as a video encoder in order to decode encoded video data. In many instances, a video encoder also includes a video decoding loop, and thus the video encoder performs video decoding as part of encoding video data. Thus, unless stated otherwise, the techniques described in this disclosure with respect to a video decoder may also be performed by a video encoder, and vice versa.

Various examples have been described. These and other examples are within the scope of the following claims.

What is claimed is:

1. A method of decoding video data, the method comprising:
determining, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values;
transforming the coefficient values of the block of coefficient values into residual samples of a residual block; and
reconstructing the current block based on a prediction block and the residual block.

2. The method of claim 1, wherein a width or height of the current block is not a multiple of 4.

3. The method of claim 1, wherein determining the coefficient values for the one or more non-square coefficient groups comprises:
determining coefficient values for a first non-square coefficient group of the one or more non-square coefficient groups; and
determining coefficient values for a second non-square coefficient group of the one or more non-square coefficient groups,
wherein a size of the first non-square coefficient group and a size of the second non-square coefficient group are different.

4. The method of claim 1, wherein the one or more non-square coefficient groups form a first part of the block of coefficient values, the method further comprising:
determining, for the current block, coefficient values for one or more square coefficient groups, wherein the one or more square coefficient groups together form a second part of the block of coefficient values.

5. The method of claim 1, further comprising:
receiving information indicative of a manner in which the block of coefficient values is partitioned,
wherein determining, for the current block, the coefficient values for one or more non-square coefficient groups comprises determining, for the current block, the coefficient values for one or more non-square coefficient groups based on the information indicative of the manner in which the block of coefficient values is partitioned.

6. The method of claim 1, wherein the current block is partitioned based on one of a quad-tree-binary-tree (QTBT) partitioning or a triple tree partitioning.

7. The method of claim 1, further comprising:
determining that the current block is of a particular color component,
wherein determining, for the current block, the coefficient values for one or more non-square coefficient groups comprises determining, for the current block, the coefficient values for one or more non-square coefficient groups, responsive to the current block being of the particular color component.

8. The method of claim 1, further comprising:
determining that the current block is of a particular block shape,
wherein determining, for the current block, the coefficient values for one or more non-square coefficient groups comprises determining, for the current block, the coefficient values for one or more non-square coefficient groups, responsive to the current block being of the particular block shape.

9. The method of claim 1, further comprising:
determining that the current block is of a particular size,
wherein determining, for the current block, the coefficient values for one or more non-square coefficient groups comprises determining, for the current block, the coefficient values for one or more non-square coefficient groups, responsive to the current block being of the particular size.

10. A method of encoding video data, the method comprising:
determining residual samples of a residual block based on a difference between a current block that is non-square and a prediction block;
transforming the residual samples of the residual block into a block of coefficient values;
partitioning the block of coefficient values into one or more non-square coefficient groups, wherein the one or more non-square coefficient groups together form at least part of the block of coefficient values, and coefficient values for the one or more non-square coefficient groups form at least a part of the coefficient values for the block of coefficient values; and
signaling information indicative of the coefficient values for the one or more square coefficient groups.

11. The method of claim 10, wherein a width or height of the current block is not a multiple of 4.

12. The method of claim 10, wherein partitioning the block of coefficient values into the one or more non-square coefficient groups comprises:
partitioning the block of coefficient values into a first non-square coefficient group of the one or more non-square coefficient groups; and
partitioning the block of coefficient values into a second non-square coefficient group of the one or more non-square coefficient groups,
wherein a size of the first non-square coefficient group and a size of the second non-square coefficient group are different.

13. The method of claim 10, wherein the one or more non-square coefficient groups form a first part of the block of coefficient values, the method further comprising:
partitioning the block of coefficient values into the one or more square coefficient groups, wherein the one or more square coefficient groups together form a second part of the block of coefficient values.

14. The method of claim 10, further comprising:
signaling information indicative of a manner in which the block of coefficient values is partitioned.

15. The method of claim 10, further comprising:
partitioning the current block based on one of a quad-tree-binary-tree (QTBT) partitioning or a triple tree partitioning.

16. The method of claim 10, further comprising:
determining that the current block is of a particular color component,
wherein partitioning the block of coefficient values into the one or more non-square coefficient groups comprises partitioning the block of coefficient values into the one or more non-square coefficient groups, responsive to the current block being of the particular color component.

17. The method of claim 10, further comprising:
determining that the current block is of a particular block shape,
wherein partitioning the block of coefficient values into the one or more non-square coefficient groups comprises partitioning the block of coefficient values into the one or more non-square coefficient groups, responsive to the current block being of the particular block shape.

18. The method of claim 1, further comprising:
determining that the current block is of a particular size,
wherein partitioning the block of coefficient values into the one or more non-square coefficient groups comprises partitioning the block of coefficient values into the one or more non-square coefficient groups, responsive to the current block being of the particular size.

19. A device for decoding video data, the device comprising:
a memory configured to store a prediction block; and
a video decoder comprising at least one of fixed-function or programmable circuitry, wherein the video decoder is configured to:
determine, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values;
transform the coefficient values of the block of coefficient values into residual samples of a residual block; and
reconstruct the current block based on the prediction block stored in memory and the residual block.

20. The device of claim 19, wherein a width or height of the current block is not a multiple of 4.

21. The device of claim 19, wherein to determine the coefficient values for the one or more non-square coefficient groups, the video decoder is configured to:
determine coefficient values for a first non-square coefficient group of the one or more non-square coefficient groups; and
determine coefficient values for a second non-square coefficient group of the one or more non-square coefficient groups,
wherein a size of the first non-square coefficient group and a size of the second non-square coefficient group are different.

22. The device of claim 19, wherein the one or more non-square coefficient groups form a first part of the block of coefficient values, and wherein the video decoder is configured to:
determine, for the current block, coefficient values for one or more square coefficient groups, wherein the one or more square coefficient groups together form a second part of the block of coefficient values.

23. The device of claim 19, wherein the video decoder is configured to:
receive information indicative of a manner in which the block of coefficient values is partitioned,
wherein to determine, for the current block, the coefficient values for one or more non-square coefficient groups, the video decoder is configured to determine, for the current block, the coefficient values for one or more non-square coefficient groups based on the information indicative of the manner in which the block of coefficient values is partitioned.

24. The device of claim 19, wherein the current block is partitioned based on one of a quad-tree-binary-tree (QTBT) partitioning or a triple tree partitioning.

25. The device of claim 19, wherein the video decoder is configured to:
determine that the current block is of a particular color component,
wherein to determine, for the current block, the coefficient values for one or more non-square coefficient groups, the video decoder is configured to determine, for the current block, the coefficient values for one or more non-square coefficient groups, responsive to the current block being of the particular color component.

26. The device of claim 19, wherein the video decoder is configured to:
determine that the current block is of a particular block shape,
wherein to determine, for the current block, the coefficient values for one or more non-square coefficient groups, the video decoder is configured to determine, for the current block, the coefficient values for one or more non-square coefficient groups, responsive to the current block being of the particular block shape.

27. The device of claim 19, wherein the video decoder is configured to:
determine that the current block is of a particular size,
wherein to determine, for the current block, the coefficient values for one or more non-square coefficient groups, the video decoder is configured to determine, for the current block, the coefficient values for one or more non-square coefficient groups, responsive to the current block being of the particular size.

28. The device of claim 19, wherein the device comprises a wireless communication device, further comprising a receiver configured to receive encoded video data.

29. The device of claim 28, wherein the wireless communication device comprises a telephone handset and wherein the receiver is configured to demodulate, according to a wireless communication standard, a signal comprising the encoded video data.

30. A computer-readable storage medium storing instructions that when executed cause one or more processors of a device for decoding video data to:
determine, for a current block that is non-square, coefficient values for one or more non-square coefficient groups, wherein the one or more non-square coefficient groups together form at least part of a block of coefficient values, and the coefficient values for the one or more non-square coefficient groups form at least a part of the coefficient values for the block of coefficient values;
transform the coefficient values of the block of coefficient values into residual samples of a residual block; and
reconstruct the current block based on a prediction block and the residual block.
